(19) United States
(12) Patent Application Publication
(10) Pub. No.: US 2009/0101502 A1
(43) Pub. Date: Apr. 23, 2009

(54) Thermal Shock Resistant Gas Sensor Element

(75) Inventors: James Richard Waldrop, Belton, SC (US); Juergen Sindel, West Bloomfield, MI (US); Juergen Reiss, Ditzingen (DE); Jeffrey McCollum, Easley, SC (US); Heiner Scheer, Greenville, SC (US)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/130,701

(22) Filed: May 30, 2008

Related U.S. Application Data
(63) Continuation-in-part of application No. 11/742,266, filed on Apr. 30, 2007.
Application No. 11/742,266 is a division of application No. 10/361,872, filed on Feb. 10, 2003, now Pat. No. 7,211,180.
(60) Provisional application No. 60/941,626, filed on Jun. 1, 2007.
(60) Provisional application No. 60/947,167, filed on Jun. 29, 2007.

(51) Int. Cl. G01N 27/26; C23C 4/10

(52) U.S. Cl. 204/424; 427/453

(57) ABSTRACT

A thermal shock resistant sensor element that includes a sensor element having a gamma alumina coating on at least a portion thereof. The thermal shock resistant sensor element may be thermal shock resistant at temperatures greater than about 600° C. A method of making a thermal shock resistant element that includes plasma spraying gamma alumina onto a sensor element to form a thermal shock resistant element. The thermal shock resistant sensor element may be thermal shock resistant at temperatures greater than about 500° C. A thermal shock resistant sensor element that includes a sensor element having an alumina coating on at least a portion thereof. The thermal shock resistant sensor element may be thermal shock resistant at temperatures greater than about 500° C. and may demonstrate a Si poisoning resistance after exposure to the Gas Burner Test (850° C.) for at least about 60 hours.

### CROSS-REFERENCE TO RELATED APPLICATIONS

This application claims priority under 35 U.S.C. § 119(e) to U.S. Provisional Patent Application No. 60/941,626 filed Jun. 1, 2007, the entire content of which is hereby incorporated by reference.

### BACKGROUND

A wide variety of gas sensors and gas sensor elements are used to measure different gases. More particularly, a sensor element of an exhaust gas sensor may be used in automotive applications to measure different gases (e.g., oxygen) in the exhaust gas.

Over time, however, different components in the exhaust gases tend to contaminate different parts of the gas sensor. More specifically, components such as lead, phosphorus, silicon, manganese, zinc, calcium, phosphates, oil ashes, rusts, metal oxides and other elements in the exhaust gas may tend to contaminate the electrode. More particularly, an outer electrode of the sensing element may be contaminated, and the porosity of the protective layer system may also be clogged, eventually affecting the functioning of the sensor and sometimes rendering the sensor or sensor element inoperable. Acidic exhaust components such as PₓO_{y} and SOₓ, wherein x and y are positive whole numbers, may also contaminate the sensor element, as well as reactive catalyst poisons such as lead, silicon and bismuth compounds.

Exhaust gas sensors may also be subjected to rapid temperature changes which can affect the function of the sensor over time. For example, ceramic sensor elements are particularly vulnerable to thermal shock, due to their low toughness, low thermal conductivity, and high thermal expansion coefficients. Thermal shock occurs when a thermal gradient causes different parts of an object to expand by different amounts. This differential expansion can be understood in terms of stress or of strain. At some point, this stress overcomes the strength of the material, causing a crack to form. If nothing stops this crack from propagating through the material, it will cause the object's structure to fail. As a result, protective coatings are continually being sought that improve the thermal shock resistance of a sensor element as well as inhibit and/or prevent contamination of sensor elements and gas sensors.

### SUMMARY

In one aspect, the invention provides a thermal shock resistant sensor element that includes a sensor element having a gamma alumina coating on at least a portion of the sensor element. The thermal shock resistant sensor element may be thermal shock resistant at temperatures greater than about 600° C.

In another aspect, the invention provides a thermal shock resistant sensor element that includes a) a substrate having a plurality of edges; b) a coating that includes gamma alumina applied to at least a portion of the substrate so that the coating does not touch or cover at least one of the edges, thereby leaving an exposed portion of the substrate not covered by the coating; and c) an adhesive adhering to at least a portion of the exposed part and at least a portion of the coating to secure the coating to the substrate. The thermal shock resistant sensor element may be thermal shock resistant at temperatures greater than about 600° C.

In yet another aspect, the invention provides a method of making a thermal shock resistant sensor element. The method includes plasma spraying gamma alumina onto a sensor element to form a thermal shock resistant sensor element. The thermal shock resistant sensor element may be thermal shock resistant at temperatures greater than about 500° C.

In a further aspect, the invention provides a thermal shock resistant sensor element that includes a sensor element having an alumina coating on at least a portion of the sensor element. The thermal shock resistant sensor element may be thermal shock resistant at temperatures greater than about 500° C. The thermal shock resistant sensor element may demonstrate a Si poisoning resistance after exposure to the Gas Burner Test (850° C.) for at least about 60 hours.

In another aspect, the invention provides a method of making a thermal shock resistant sensor element. The method includes plasma spraying alumina onto a sensor element to form a thermal shock resistant sensor element. The thermal shock resistant sensor element may be thermal shock resistant at temperatures greater than about 500° C. The thermal shock resistant sensor element may demonstrate a Si poisoning resistance after exposure to the Gas Burner Test (850° C.) for at least about 60 hours.

Other aspects of the invention will become apparent by consideration of the detailed description and accompanying drawings.

### BRIEF DESCRIPTION OF THE DRAWINGS

FIG. 1 shows a cross-section through an exhaust-gas-side part of a sensor element.

FIG. 2 shows an enlarged view of a layer system of the sensor element illustrated in FIG. 1.

FIG. 3 shows a cross-section (similar to FIG. 1), in which a contamination-resistant coating is applied using an adhesive.

FIG. 4 shows a cross-section (similar to FIG. 1), in which another contamination-resistant coating is applied using a different adhesive application technique.

FIG. 5 shows a cross-section (similar to FIG. 1), in which another contamination-resistant coating is applied using a different adhesive application technique.

FIG. 6 shows a cross-section (similar to FIG. 1), in which another contamination-resistant coating is applied using a different adhesive application technique.

FIG. 7 shows a cross-section (similar to FIG. 1), in which no protective porous layer is applied to the sensor element, to which the contamination-resistant coating adheres.

FIGS. 8a and 8b are side views of a sensor element in which a thermal shock resistant coating has been applied to the tip of the sensor.

FIG. 9 is a side view of a sensor element in which a thermal shock resistant coating has been applied to the tip of the sensor.

FIG. 10 is a side view of a sensor element without (left) and with (right) a thermal shock resistant coating.

FIG. 11 is a graph comparing the shock resistance of a sensor element on which a thermal shock resistant coating according to Example 1 has been applied to the tip of the sensor to a sensor element on which no thermal shock resistant coating has been applied.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

In one aspect, the invention may provide a thermal shock resistant sensor element comprising a thermal shock resistant coating on at least a portion thereof. The coating may comprise high purity gamma alumina. As used herein, the term “high purity” means at least about 95% pure, particularly about 98% pure, more particularly about 99% pure.

In another aspect, the invention may provide a method of making a contamination-resistant sensor element. The method generally includes applying high purity gamma alumina to a substrate using plasma spraying techniques.

A plate-shaped or planar sensor element 10 of an automotive gas sensor is illustrated in the figures as described above. The protective coatings described herein may be applied to this specific sensor planar sensor element (described below), as well as to a wide variety of sensor elements as will be understood by those of ordinary skill in the art. In other words, the application of the protective coatings of the present invention as described herein should in no way be limited to the particular sensor element described below. Sensor element 10 is intended to be one illustrative example. For example, other relevant sensor elements and coatings are described in U.S. Pat. No. 7,211,180, and U.S. patent application Ser. No. 11/742,266 filed on Apr. 30, 2007, which are hereby fully incorporated by reference in their entirety. In one embodiment, the sensor element may be part of a stoichiometric or wide band automotive exhaust gas sensor.

The sensor element 10 of the figures has an electrochemical measuring cell 12 and a heating element 14. Measuring cell 12 has, for example, a first solid electrolyte foil 21 with a top surface 22 on the measured gas side and a large surface 23 on the reference gas side, as well as a second solid electrolyte foil 25 with a reference channel 26 integrated therein. On large surface 22 on the measured gas side there is a measuring electrode 31 with a printed conductor 32 and a first terminal contact 33. On large surface 23 on the reference gas side of first solid electrolyte foil 21, there is a reference electrode 35 with a printed conductor 36. Furthermore, a through-plating 38 is provided in first solid electrolyte foil 21, through which printed conductor 36 of reference electrode 35 is guided to large surface 22 on the measured gas side. In addition, first terminal contact 33, a second terminal contact 39, connected to through-plating 38 and thus forming the contact point for reference electrode 35, is also located on large surface 22. Measuring electrode 31 is covered with a porous protective layer 28.

The porous protective layer 28 may comprise at least one of a zirconium oxide, aluminum oxide, titanium oxide, magnesium oxide, and a combination thereof. The porosity of the coating is generally greater than about 10 percent, and more particularly, greater than about 25 percent. The porosity is usually less than about 75 percent, and more particularly, less than about 55 percent. Generally the protective layer 28 is sintered at a high temperature and is mechanically very robust. The thickness of the layer 28 may be greater than about 30 microns. Generally, the thickness of the layer 28 is less than about 250 microns.

The heating element 14 has, for example, a support foil 41 with an outer large surface 43 and an inner large surface 43′, which, in this embodiment is composed of the material of the two solid electrolyte foils 21, 25. An outer insulation layer 42 may be applied to inner large surface 43′ of support foil 41. A resistance heater 44 with a wave-form heating conductor 45 and two terminal conductors 46 is located on outer insulation layer 42. Outer insulation layer 42 and support foil 41 have two heater through-platings 48 each flush to one another, which run from the two terminal conductors 46 to outer large surface 43 of support foil 41. Two heater terminal contacts 49 are arranged on outer large surface 43 of support foil 41, which are connected to heater through-platings 48.

An inner insulation layer 50 is on resistance heater 44. The large surface of inner insulation layer 50 is connected to the large surface of the second solid electrolyte foil 25. Thus heating element 14 is thermally connected to measuring cell 12 via inner insulation layer 50.

The two solid electrolyte foils 21 and 25 and support foil 41 may be composed of ZrO₂, partially stabilized with 5 mol. percent Y₂O₃, for example. Electrodes 31, 35, printed conductors 32, 36, through-platings 38 and terminal contacts 33, 39 are made of platinum cermet, for example. In this embodiment, a platinum cermet is also used as the material for the resistance heater, the ohmic resistance of leads 46 being selected to be less than that of heating conductor 45.

In some embodiments of the present invention, a protective coating is applied to at least a portion of a sensor element to improve the contamination (or poisoning) resistance of the sensor element. In other embodiments, the protective coating is applied to all sides of at least a portion of the sensor element to improve both the contamination resistance and thermal shock resistance of the sensor element.

The protective coating comprises high purity gamma alumina, such as Ceralox TSA-200/20 (available from SASOL North America, Tucson, Ariz.). The high purity gamma alumina is applied to the sensor element using any number of plasma spray techniques. Generally, the process involves introducing the high purity gamma alumina into a plasma jet where the alumina is formed into molten droplets and propelled towards the sensor element. There, the molten droplets flatten, rapidly solidify and form a protective coating. Plasma spraying equipment and methods are well-known to those skilled in the art. In one example, high purity gamma alumina is applied to a sensor element with an F4-Type Burner (available from Sulzer-Metco, Westbury, N.Y.) using the following ranges of plasma spray parameter settings:
Argon (burner): From about 7 to about 17 Normal Liters Per Minute (NLPM), particularly from about 8 to about 15 NLPM, and more particularly from about 9 to about 10 NLPM;
Nitrogen (burner): From about 0 to about 14 NLPM, particularly from about 5 to about 13 NLPM, and more particularly from about 12 to about 13 NLPM;
Hydrogen (burner): From about 0 to about 4 NLPM;
Argon (feeder): From about 2 to about 4 NLPM, particularly from about 2.5 to about 3.9 NLPM;
Current: From about 350 to about 535 amps, particularly from about 400 to about 500 amps; and more particularly from about 425 to about 450 amps;
Rotation Speed: From about 50 to about 1000 RPM, particularly from about 50 to about 200 RPM, and more particularly from about 75 to about 85 RPM;
Powder Feed: From about 5 to about 35 grams per minute, particularly from about 10 to about 20 gr/min, and more particularly from about 16 to about 18 gr/min;
Traverse Speed: From about 5 to about 24 mm/sec, particularly from about 10 to about 15 mm/sec, and more particularly from about 7 to about 9 mm/sec;
Cycles: From about 1 to about 4, particularly from about 1 to about 3, and more particularly about 2;
Spray Angle: From about 60° to about 90°, particularly from about 60° to about 70°;
Burner Distance: From about 95 to about 135 mm, particularly from about 100 to about 120 mm, and more particularly from about 107 to about 117 mm; and
Cooling Air: From about 1100 to about 2800 scfh, more particularly from about 2000 to about 2600 scfh.

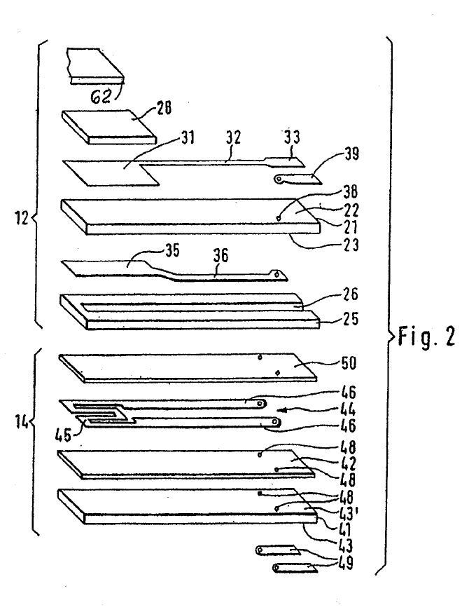

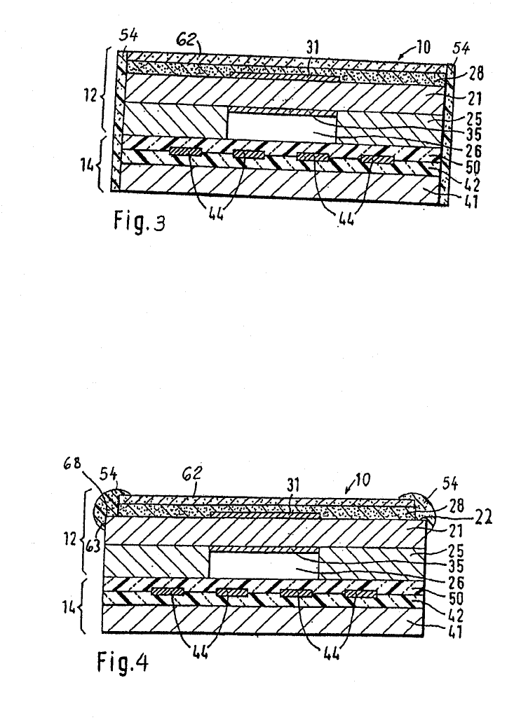

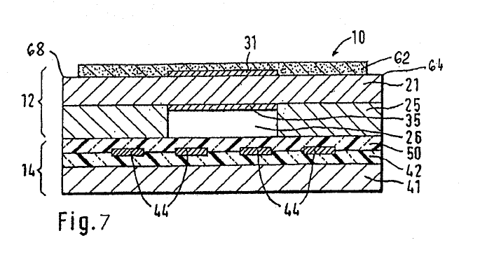

The protective coating 62 may be applied to at least a portion of one side of a sensor element as illustrated in FIGS. 2-7. The protective coating 62 may be applied as a mono-, duplex-, or multi-layer directly or indirectly to the measuring electrode 31. In other words, the protective coating 62 may be applied directly to the measuring electrode, or may have one or more additional layers therebetween. For example, in one embodiment, the protective coating 62 may be applied to the electrode cover layer or porous protective layer 28, which covers the measuring electrode. This is shown, e.g., in FIGS. 3-6, wherein the protective coating 62 is applied (albeit indirectly) to the electrode 31. On the other hand, FIG. 7 shows the protective coating 62 being applied directly to the electrode 31 and substrate 21. Accordingly, as used herein, applying one substance to another, or one substance being “on” another substance, may mean directly or indirectly unless specifically stated otherwise.

In one embodiment, the protective coating 62 may be applied in such a way that it does not touch or cover the edges of a substrate or planar element to which it is applied. The substrate may be the electrolyte foil 21, electrode 31, or protective layer 28, among others. FIG. 7 shows the protective coating 62 being applied in such a manner that the protective coating 62 does not cover the edges 64, 68 of the substrate 21. Any of the substrates to which the protective coating 62 adheres may have a plurality of edges, at least one of which the protective coating 62 may not cover. This leaves a part of the substrate that is not covered by the protective coating 62, and to which an adhesive (discussed below) may adhere to further secure the coating.

In another embodiment, a thin adhesion layer may be used to further improve adhesion of the protective coating 62 to the measuring electrode. The adhesion layer may be applied directly to the electrode 31 or to the porous protective layer 28, which covers the measuring electrode 31. The thin adhesion layer may comprise at least one of a composition made from an oxide of boron, aluminum, magnesium, zirconium, silicon, and combinations thereof. The adhesion layer may be continuous, or it may be textured, i.e., it may be the product of windows or dots. Generally, the thickness of the adhesion layer is less than about 10 μm. More particularly, the thickness is generally less than about 8 μm, and even more particularly, less than about 5 μm. The thickness of the adhesion layer may be generally greater than about 0.1 μm, and is usually greater than about 0.5 μm or about 1 μm. In another embodiment, the thickness of the adhesion layer is less than about 20 μm, particularly less than about 15 μm, and more particularly from about 11 to about 13 μm.

The adhesion layer may be sufficiently porous to allow exhaust gases to pass through. An adhesive paste may be used to formulate the adhesion layer. The porosity of an adhesive paste may be at least 5 (vol %), particularly at least 15 (vol %), and more particularly at least about 25 (vol %). The porosity of the adhesive paste may be less than about 30 (vol %), particularly less than about 15 (vol %), more particularly less than about 10 (vol %). This includes embodiments where the porosity of the adhesive paste may be about 5 (vol %) to about 30 (vol %), more particularly about 5 (vol %) to about 15 (vol %), and more particularly about 11 (vol %). After the adhesive paste has been fired, the carbon volume to aluminum oxide volume for the fired adhesion layer may be from about 20 (vol %) to about 70 (vol %), particularly from about 30 (vol %) to about 40 (vol %), more particularly about 35 (vol %).

An exemplary adhesion layer may comprise at least one of fine alumina, coarse alumina, an organic pore former, a plasticizer, a solvent, a binder material, and combinations thereof.

Organic pore formers include, but are not limited to, at least one of glassy carbon. Specific examples of glassy carbon include, but are not limited to, at least one of Sigradur K dust A, Sigradur G dust A (both available from Sigradur, Germany), and combinations thereof.

Plasticizers include, but are not limited to, at least one of dioctyl phthalate, dibutyl phthalate, and combinations thereof.

Solvents include, but are not limited to, diethylene glycol.

Binder materials include, but are not limited to, at least one of polyvinyl butyral, acrylic polymers, and combinations thereof.

The fine alumina may have a D₅₀ particle distribution in the range of about 0.15 to about 0.35 μm. Sources of fine alumina include High Purity Alumina AKP 53 (available from Solvadis Chemag AG, Frankfurt, Germany). The concentration of fine alumina in the adhesive may be less than about 60% (by wt.), particularly less than about 55% (by wt.), and more particularly less than about 45% (by wt.). The concentration of fine alumina in the adhesive may be at least about 40% (by wt.), particularly at least about 45% (by wt), and more particularly at least about 50% (by wt.). This includes embodiments where the concentration of fine alumina in the adhesive may be from about 40% (by wt) to about 60% (by wt.).

In another embodiment, the concentration of fine alumina in the adhesive may be from about 20 to about 40% (by wt.), particularly from about 20 to about 30 % (by wt.), and more particularly from about 22 to about 27% (by wt.).

The coarse alumina may have a D₅₀ particle distribution in the range of about 16 to about 26 μm. Sources of coarse alumina include Advanced Alumina AA-18 (available from Sumitomo Chemical Co., Ltd.). The concentration of coarse alumina in the adhesive may be less than about 60% (by wt.), particularly less than about 55% (by wt.), and more particularly less than about 45% (by wt.). The concentration of coarse alumina in the adhesive may be at least about 40% (by wt.), particularly at least about 45% (by wt.), and more particularly at least about 50% (by wt.). This includes embodiments where the concentration of coarse alumina in the adhesive may be from about 40% (by wt.) to about 60% (by wt.).

In another embodiment, the concentration of coarse alumina in the adhesive may be from about 20 to about 40% (by wt.), particularly from about 20 to about 30 % (by wt.), and more particularly from about 22 to about 27% (by wt.).

The concentration of organic pore former in the adhesive may be less than about 40% (by wt.), particularly less than about 30% (by wt.), and more particularly less than about 20% (by wt.). The concentration of organic pore former in the adhesive may be at least about 10% (by wt.), particularly at least about 20% (by wt.), and more particularly at least about 30% (by wt.). This includes embodiments where the concentration of organic pore former in the adhesive may be from about 10% (by wt.) to about 40% (by wt.).

In another embodiment, the concentration of organic pore former in the adhesive may be from about 8 about 40% (by wt.), particularly from about 8 to about 30% (by wt.), and more particularly from about 8 to about 10% (by wt.).

The concentration of the plasticizer in the adhesive may be from about 1 to about 6%, and more particularly from about 1.5 to about 5% (by wt.). In one embodiment, the plasticizer may be dioctyl phthalate and the concentration of dioctyl phthalate in the adhesive may be from about 3 to about 5% (by wt.). In another embodiment, the plasticizer may be dibutyl phthalate and the concentration of dibutyl phthalate may be from about 1.5 to about 5% (by wt.).

The concentration of the solvent in the adhesive may be from about 20 to about 50% (by wt.), particularly from about 25 to about 40% (by wt.), and more particularly from about 25 to about 35% (by wt.).

The concentration of the binder material in the adhesive may be from about 4 to about 9% (by wt.), and more particularly from about 5 to about 8% (by wt.). In another embodiment, the concentration of the binder material in the adhesive may be from about 7 to about 9% (by wt.).

In one embodiment, the adhesion formulation may comprise 728.1±0.3 g High Purity Alumina AKP 53 (available from Solvadis Chemag AG, Frankfurt, Germany), 738.6±0.3 g Advanced Alumina AA-18 (available from Sumitomo Chemical Co., Ltd.); 305.7±0.2 g glassy carbon (Sigradur K dust A), 126.3±0.2 g dioctyl phthalate, 868.5±0.3 g diethylene glycol, and 232.8±0.2 g polyvinyl butyral.

In another embodiment, the adhesion formulation may comprise 735.2±0.3 g High Purity Alumina AKP 53, 745.6±0.3 g Advanced Alumina AA-18; 284.8±0.2 g glassy carbon (Sigradur G dust A), 64.4±0.2 g dibutyl phthalate, 999.5±0.3 g diethylene glycol, and 170.5±0.2 g polyvinyl butyral.

In a different application embodiment, the surface of a co-sintered electrode cover layer or protective layer 28 is mechanically structured to further improve adhesion of said protective coating 62. Again, these layers may be made from Al- or Zr-oxides. Typical mechanical structuring may include grinding, cutting, and combinations thereof. In yet a further embodiment, the surface of an electrode cover layer or porous protective layer 28 may be structured prior to co-sintering to further improve adhesion of said protective coating 62. An example for this type of structuring is to screen print patterns such as lines, grids, or dots.

FIGS. 3-7 illustrate additional application embodiments. For these embodiments, a dense adhesive paste 54 having strong adhesive power may be applied using one of the ways shown in FIGS. 3-6, or a combination thereof, to connect the layer 28, substrate 21, or both with the protective coating 62 in a frame- or clamp-like fashion. Generally the paste has a very low porosity, and therefore, would render the sensor element as non-functioning if it were applied on to the electrode or electrode protective layer. The adhesive or paste may comprise B, Si, or Na compounds. Examples of such a paste include, but are not limited to, Cercoat® and Bondceram® brands that may be obtained from Hottec Inc., Norwich, Conn. Applying the adhesive as shown in FIGS. 3-6 increases the mechanical robustness and stability of the protective coating 62.

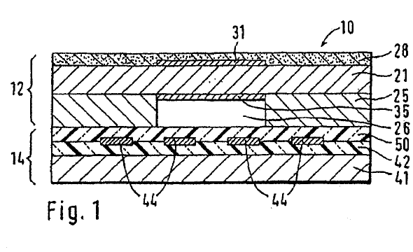

Again, FIGS. 3-7 are each cross-sections similar to the cross-section shown in FIG. 1. More particularly, FIG. 3 shows the adhesive paste 54 being applied to the sides of the layer 28, as well as the sides of the protective coating 62. In fact, the adhesive 54 may be applied to an entire side or sides of the sensor element 10 as shown in FIG. 3.

FIGS. 4-7 more clearly show the washcoat or protective coating 62 being applied in such a manner that it does not extend to the edges of the substrate 21 to which it is either directly or indirectly applied. The protective coating 62 may also not extend to at least one of the edges of the layer 28 to which it may be applied (not shown).

FIG. 4 shows the adhesive paste 54 being applied as a frame only on the upper edges of the substrate 21, as well as the outer edges of the layer 28 and protective coating 62. The adhesive 54 may also be applied to the top surface 22 of the substrate 21 as well as its side 63. The adhesive 54 may be applied to the top surface 22 of the substrate 21, such that it touches or covers one or both of the substrate's 21 edges 68. FIG. 4 shows the adhesive being applied to fill this gap between the protective coating 62 and the outer edge 68 of the substrate 21 as, again, the protective coating 62 may not extend to the substrate's edges for the reasons set forth above. In an alternative embodiment layer 28 may be eliminated.

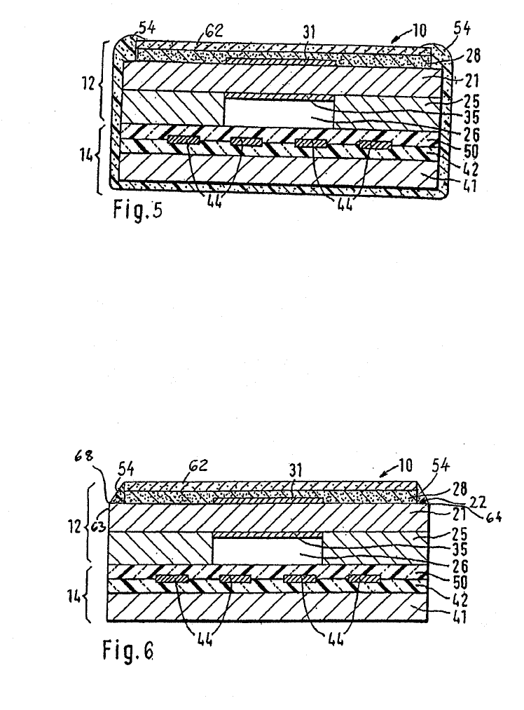

FIG. 5 shows another variation of the adhesive system set forth in FIG. 4. More particularly, the adhesive 54 starts from its position shown in FIG. 4, but extends around three sides of the sensor element. In an alternative embodiment, layer 28 may be eliminated.

FIG. 6 shows another adhesive variation. In this embodiment, the adhesive 54 only adheres to the top surface 22 of the foil or substrate 21, and not its sides 63. The adhesive 54 fills the gap between the protective coating 62, layer 28 and edges 64, 68 of the substrate 21. Again, layer 28 in this embodiment may be eliminated.

In summary, while FIGS. 3-6 show the protective coating 62 being applied to layer 28, which ultimately adheres to substrate 21, the layer 28 may be eliminated in any of the embodiments. FIG. 7 shows the protective coating 62 being applied directly to the substrate 21. Any of the adhesive techniques shown in FIGS. 3-6 may be applied to the embodiment shown in FIG. 7. Alternatively, at least one of layer 28 and protective coating 62 may extend to one or more edges of the substrate 21.

The protective coating 62 may have boundaries that are rounded. The boundaries of the contamination-preventing layer may be controlled by using a frame or template to cover the edges of the planar element prior to applying the protective coating 62 by plasma spraying. The frames or templates may be used to ensure that the protective coating 62 does not extend to the substrate's (to which it adheres) edges when so desired.

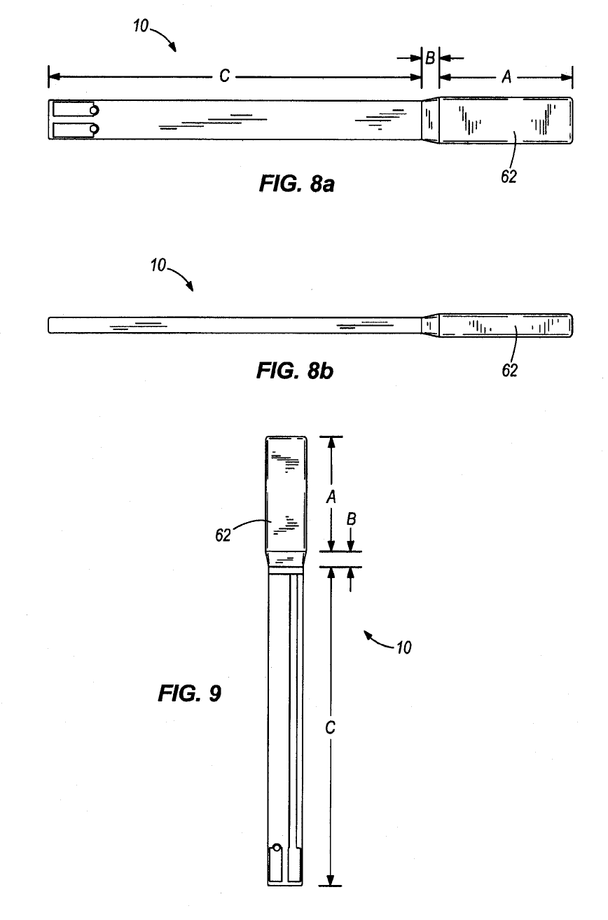

FIGS. 2-7 show a protective coating 62 on primarily one side of a sensor element 10. However, the protective coating 62 may also be applied to all sides of at least a portion of a sensor element 10 as illustrated in FIGS. 8-10. For example, in FIGS. 8a-b, Region A of the sensor element 10 is covered or encompassed on all sides by the protective coating 62. By encompassing all sides of the sensor element 10 with the protective coating 62, the sensor element 10 exhibits greater thermal shock resistance than would be obtained by applying a protective coating 62 to only one side of the sensor element 10. A protective coating 62 applied in such a manner would enhance both the contamination resistance and thermal shock resistance of the sensor element.

In some embodiments, the protective coating 62 may improve the thermal shock resistance of a planar type ceramic oxygen sensor from about 300° C. to a minimum of about 500° C., 550° C., 600° C., 650° C., 700° C., 750° C., 800° C., 850° C., 900° C., 950° C. and even 1000° C. In one embodiment, the protective coating 62 may improve the thermal shock resistance of a planar type ceramic oxygen sensor from about 300° C. to a minimum of about 700° C.

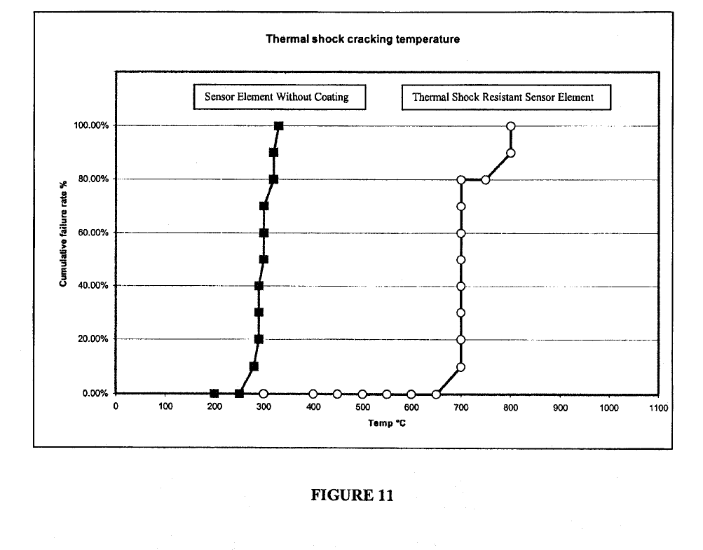

FIG. 11 demonstrates the improved shock resistance of a sensor element on which the thermal shock resistant coating of Example 1 has been applied to the tip of the sensor by comparing it to a sensor element on which no thermal shock resistant coating has been applied.

To test thermal shock resistance, an element is connected to a power supply and a heater voltage is adjusted to provide a desired temperature and hot spot. Temperature may be tested from about 200° C. to about 1000° C. in 50° C. increments. 10 μl of water is sprayed on the hottest spot of the heater side of the sensor by using a mechanically actuated 50 μl syringe and a precision needle. The sensor element is then cooled and checked for cracks. Visible damage to the element, catastrophic failures in the element, or cracks in the element or element coating that will compromise the reference air isolation means a failure in thermal shock resistance.

In some embodiments the protective coating 62 may improve the Si poisoning resistance of a planar type ceramic oxygen sensor from about 10 hours exposure limit to a minimum of about 60 hours exposure limit, particularly to a minimum of about 90 hours exposure limit. Si poisoning can occur from a source of contamination. Silicon can coat the outside of the sensor element to form a dense glass, which may prevent the element from responding to changes in gas.

To test the Si poisoning resistance, the Gas Burner Test (850° C.) is conducted on sensors to determine the time it takes the sensors to respond to a shift from a rich gas environment to a lean gas environment, and vice versa. The Gas Burner Test can also be done at 350° C. The sensors are then fitted in an exhaust pipe of a λ=1 controlled engine with the following conditions: exhaust gas temperature 400° C. (+/±15° C.); test time 90 hours; and Si content in the fuel 0.41 cm³/l oktamethylcyclotetrasiloxane. The oktamethylcyclotetrasiloxane may be substituted with a mixture of 33.3% hexamethyldisiloxane, (CH₃)₃SiOSi(CH₃)₃, 33.3% tetramethyldisiloxane (CH₃)₂HSiOSiH(CH₃)₂, and 33.3% tetramethyldivinyldisiloxane (CH₃)₂(C₂H₃)SiOSi(C₂H₃)(CH₃)₂. The Gas Burner Test (850° C.) is then conducted a second time on the sensors, and the time it takes the sensors to respond to a shift from a rich gas environment to a lean gas environment, and vice versa, is again measured. The sensors demonstrate poisoning resistance when the difference in the sensor response times before and after exposure to the silicon fuel are ≦+50 msec and the shift in response difference is ≦70 msec. Additionally, the poisoning resistance sensors when analyzed using the synthetic gas test stand (PSG) test exhibit lambda static value between 1.000 and 1.016.

The thickness of the protective coating 62 is approximately constant in Region A but gradually tapers to zero in Region B. Region C represents the uncoated portion of the sensor element. The thickness of the protective coating 62 in Region A may have a thickness of at least about 250 μm, particularly at least about 275 μm, and more particularly at least about 325 μm. The thickness may be less than about 350 μm, particularly less about 325 μm, and more particularly less than about 275 μm. This includes embodiments where the thickness of the protective coating 62 may be about 250 μm to about 350 μm. This further includes embodiments where the thickness of the protective coating 62 may be about 300 μm. In another embodiment, if a faster response time is desired, the thickness of the protective coating can be reduced. This may result in the coating having less thermal shock resistance.

In the embodiment represented by FIG. 9, Region A is about 12 mm in length, Region B is about 2 mm in length and Region C is about 42.6 mm in length. In another embodiment, Region A is about 15 mm in length, Region B is about 2 mm in length, and Region C is about 42.6 mm in length. In other embodiments, Region A may be about 10 to about 18 mm in length, Region B may be about 1 to about 3 mm in length, and Region C may be about 40 mm to about 45 mm in length, particularly from about 40.6 mm to about 43.6 mm in length.

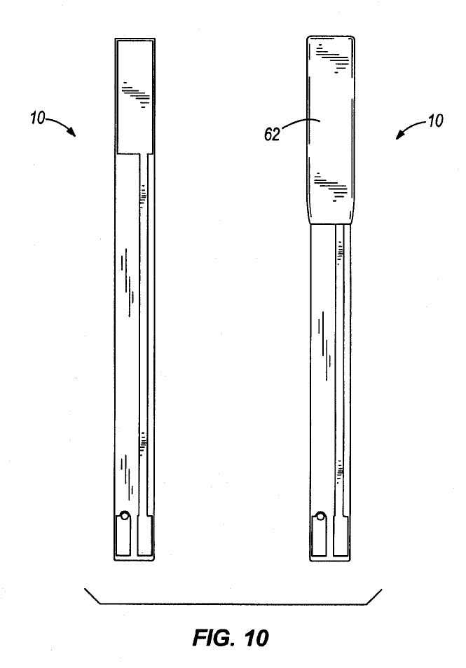

FIG. 10 is a side view of a sensor element without (left) and with (right) a protective coating 62. The protective coating 62 extends about ⅓ of the way down the sensor element 10. However, the coating can be applied so as to extend any length down the sensor element 10.

After the protective coating 62 has been applied to the sensor element 10, the sensor element 10 may be temperature treated. The temperature treatment is not necessary to the formation of the protective coating 62 but may be required for the treatment of other components present in the sensor element.

The smoothness of the protective coating 62 may be determined by the coating roughness Rt value. The coating roughness Rt value is determined by dragging a stylus 12 mm up the sensor coating 62 to measure the depth of the peaks and valleys in the protective coating 62. A coating roughness Rt value of 120 μm means that the distance between the highest peak and lowest valley does not exceed a value of 120 μm. The coating roughness Rt values of the protective coatings 62 may range from 0 to about 120 μm, particularly from 0 to about 80 μm, and more particularly from 0 to about 70 μm. This includes embodiments where the coating roughness Rt value is 120 μm, particularly 80 μm, and more particularly 65 μm.

The porosity of the protective coating 62 may be less than about 45 (vol %), particularly less about 30 (vol %), and more particularly less than about 25 (vol %). The porosity of the protective coating may be at least about 10 (vol %), particularly at least about 25 (vol %), and more particularly at least about 35 (vol %). This includes embodiments where the porosity of the protective coating 62 may be about 10 (vol %) to about 45 (vol %). This further includes embodiment where the porosity of the protective coating may be about 15 (vol %).

### EXAMPLES

Exemplary embodiments of the present invention are provided in the following examples. The following examples are presented to illustrate the present invention and to assist one of ordinary skill in making and using the same. The examples are not intended in any way to otherwise limit the scope of the invention.

### Example 1

A high purity gamma alumina coating (Ceralox TSA-200/20, available from SASOL North America, Tucson, Ariz.) was applied to a sensor element using an F4-Type Burner (available from Sulzer-Metco, Westbury, N.Y.) using the following ranges of plasma spray parameter settings: Argon (burner) 10 Normal Liters Per Minute (NLPM); Nitrogen (burner) 12 NLPM; Hydrogen (burner) 0 NLPM; Argon (feeder) 3.9 NLPM; Current 425 amps; Rotation Speed 80 RPM; Powder Feed 40.00% (18 gr/min); Traverse Speed 8 mm/sec; Cycles 2; Spray Angle 60°; Burner Distance 117 mm; and Cooling Air 3 Bar.

The adhesion formulation used comprised 728.1±0.3 g High Purity Alumina AKP 53 (available from Solvadis Chemag AG, Frankfurt, Germany), 738.6±0.3 g Advanced Alumina AA-18 (available from Sumitomo Chemical Co., Ltd.); 305.7±0.2 g glassy carbon (Sigradur K dust A), 126.3±0.2 g dioctyl phthalate, 868.5±0.3 g diethylene glycol, and 232.8±0.2 g polyvinyl butyral.

FIG. 11 demonstrates the improved shock resistance of a sensor element on which the thermal shock resistant coating of Example 1 was applied to the tip of the sensor by comparing it to a sensor element on which no thermal shock resistant coating was applied. The sensor element of Example 1 demonstrated a Si poisoning resistance for at least about 60 hours.

### Example 2

A high purity gamma alumina coating (Ceralox TSA-200/20, available from SASOL North America, Tucson, Ariz.) was applied to a sensor element using an F4-Type Burner (available from Sulzer-Metco, Westbury, N.Y.) using the following ranges of plasma spray parameter settings: Argon (burner) 9 Normal Liters Per Minute (NLPM); Nitrogen (burner) 13 NLPM; Hydrogen (burner) 0 NLPM; Argon (feeder) 2.5 NLPM; Current 450 amps; Rotation Speed 80 RPM; Powder Feed 16 gr/min; Traverse Speed 8 mm/sec; Cycles 2; Spray Angle 60°; Burner Distance 107 mm; and Cooling Air 2600 scfh.

The adhesion formulation used comprised 735.2±0.3 g High Purity Alumina AKP 53, 745.6±0.3 g Advanced Alumina AA-18; 284.8±0.2 g glassy carbon (Sigradur G dust A), 64.4±0.2 g dibutyl phthalate, 999.5±0.3 g diethylene glycol, and 170.5±0.2 g polyvinyl butyral.

The thermal shock resistance of the sensor element was at least about 700° C. The results for thermal shock resistance of the sensor element of Example 2 will be similar to that demonstrated in FIG. 11. The sensor element of Example 2 demonstrated a Si poisoning resistance for at least about 60 hours.

What is claimed is:

1. A thermal shock resistant sensor element comprising a sensor element having a gamma alumina coating on at least a portion thereof, the thermal shock resistant sensor element being thermal shock resistant at temperatures greater than about 600° C.

2. The element of claim 1, wherein the coating comprises high purity gamma alumina.

3. The element of claim 1, wherein the thermal shock resistant sensor element is thermal shock resistant at temperatures greater than about 700° C.

4. The element of claim 1, wherein the coating encompasses all sides of the element.

5. The element of claim 1, wherein the coating has rounded boundaries.

6. The element of claim 1, wherein the portion of the element is a substrate having a plurality of edges, and wherein the coating does not touch or cover at least one of the edges.

7. The element of claim 6, wherein the substrate is a surface of an electrolyte foil, and the surface has an exposed portion that is not covered by the coating.

8. The element of claim 7, wherein the coating at least partially covers an electrode.

9. The element of claim 7, wherein an adhesive is used to secure the coating to the substrate, and the adhesive adheres to at least a portion of the exposed portion and at least a portion of the coating.

10. The element of claim 9, wherein the adhesive comprises alumina, an organic pore former, a plasticizer, a solvent, a binder material, and a combination thereof.

11. The element of claim 9, wherein the adhesive is fired and the fired adhesion layer has a porosity of about 30 (vol %) to about 40 (vol %).

12. The element of claim 1, further comprising a porous protective layer comprising at least one of zirconium oxide, aluminum oxide, titanium oxide, magnesium oxide, and a combination thereof positioned between the coating and the foil.

13. The element of claim 1, wherein the gamma alumina coating is applied to the sensor element using plasma spray techniques.

14. The element of claim 1, wherein the thermal shock resistant sensor element demonstrates a Si poisoning resistance after exposure to the Gas Burner Test (850° C.) for at least about 60 hours.

15. The element of claim 1, wherein the thermal shock resistant sensor element demonstrates a Si poisoning resistance after exposure to the Gas Burner Test (850° C.) for at least about 90 hours.

16. The element of claim 1, wherein the coating has a thickness of about 250 to about 350 microns.

17. The element of claim 1, wherein the coating has a thickness of about 275 to about 325 microns.

18. The element of claim 1, wherein the coating has a porosity of about 10 (vol %) to about 45 (vol %).

19. The element of claim 1, wherein the thermal shock resistant sensor element is a part of an automotive exhaust gas sensor.

20. The element of claim 19, wherein the automotive exhaust gas sensor is a stoichiometric or wide band automotive exhaust gas sensor.

21. A thermal shock resistant sensor element comprising:
a substrate having a plurality of edges;
a coating comprising gamma alumina applied to at least a portion of the substrate such that the coating does not touch or cover at least one of the edges, thereby leaving an exposed part of the substrate not covered by the coating; and
an adhesive adhering to at least a portion of the exposed part and at least a portion of the coating to secure the coating to the substrate;
the thermal shock resistant sensor element being thermal shock resistant at temperatures greater than about 600° C.

22. The element of claim 21, wherein the gamma alumina comprises high purity gamma alumina.

23. A method of making a thermal shock resistant sensor element, the method comprising:
plasma spraying gamma alumina onto a sensor element to form a thermal shock resistant sensor element, the thermal shock resistant sensor element being thermal shock resistant at temperatures greater than about 500° C.

24. The method of claim 23, wherein the gamma alumina comprises high purity gamma alumina.

25. The method of claim 23, wherein applying a high purity gamma alumina coating to a sensor element comprises using a frame, a template, or a combination thereof to expose only a portion of the element to the plasma sprayed coating.

26. The method of claim 23, wherein the thermal shock resistant sensor element is thermal shock resistant at temperatures greater than about 600° C.

27. The method of claim 23, wherein the thermal shock resistant sensor element is thermal shock resistant at temperatures greater than about 700° C.

28. The method of claim 23, wherein the thermal shock resistant sensor element demonstrates a Si poisoning resistance after exposure to the Gas Burner Test (850° C.) for at least about 60 hours.

29. The method of claim 23, wherein the thermal shock resistant sensor element demonstrates a Si poisoning resistance after exposure to the Gas Burner Test (850° C.) for at least about 90 hours.

30. The method of claim 23, wherein the coating encompasses all sides of the element.

31. The method of claim 23, wherein the coating has rounded boundaries.

32. The method of claim 23, wherein the portion of the element is a substrate having a plurality of edges, and wherein the coating does not touch or cover at least one of the edges.

33. The method of claim 32, wherein the substrate is a surface of an electrolyte foil, and the surface has an exposed portion that is not covered by the coating.

34. The method of claim 33, wherein the coating at least partially covers an electrode.

35. The method of claim 33, wherein an adhesive is used to secure the coating to the substrate, and the adhesive adheres to at least a portion of the exposed portion and at least a portion of the coating.

36. The method of claim 23, further comprising applying a porous protective layer to the sensor element, wherein the porous protective layer is positioned between the coating and the foil.

37. A thermal shock resistant sensor element comprising a sensor element having an alumina coating on at least a portion thereof, the thermal shock resistant sensor element being thermal shock resistant at temperatures greater than about 500° C. and demonstrating a Si poisoning resistance after exposure to the Gas Burner Test (850° C.) for at least about 60 hours.

38. The element of claim 37, wherein the thermal shock resistant sensor element is thermal shock resistant at temperatures greater than about 600° C.

39. A method of making a thermal shock resistant sensor element, the method comprising:
plasma spraying alumina onto a sensor element to form a thermal shock resistant sensor element, the thermal shock resistant sensor element being thermal shock resistant at temperatures greater than about 500° C. and demonstrating a Si poisoning resistance after exposure to the Gas Burner Test (850° C.) for at least about 60 hours.

40. The method of claim 39, wherein the thermal shock resistant sensor element is thermal shock resistant at temperatures greater than about 600° C.
